(19) United States
(12) Patent Application Publication
(10) Pub. No.: US 2026/0153743 A1
(43) Pub. Date: Jun. 4, 2026

(54) OPTICAL WAVEGUIDE ASSEMBLY AND HEAD-MOUNTED DISPLAY DEVICE

(71) Applicants: Interface Advanced Technology (Chengdu) Co., Ltd., Chengdu (CN); Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: Jin-Mao ZHUANG, Zhunan (TW); Hui-Ping SHEN, Zhunan (TW); Yun-Pei CHEN, Zhunan (TW); Po-Lun CHEN, Zhunan (TW); Hsien-Ying CHOU, Hsinchu (TW)

(21) Appl. No.: 19/459,186

(22) Filed: Jan. 26, 2026

Related U.S. Application Data
(63) Continuation-in-part of application No. PCT/CN2025/086150, filed on Mar. 31, 2025.

(51) Int. Cl. G02B 27/01

(52) U.S. Cl. CPC G02B 27/0172

(57) ABSTRACT

An optical waveguide assembly includes: a waveguide comprising a first surface and a second surface opposite to the first surface; a coupling-in grating; a coupling-out grating spaced apart from the coupling-in grating, wherein the coupling-in grating and the coupling-out grating are on a same surface of the waveguide or on the first surface and the second surface of the waveguide, respectively; the waveguide is used to guide the image light toward the coupling-out grating, and the coupling-out grating is used to couple the image light out of the waveguide; and a first lens fixed to a side of the waveguide emitting the image light and used to refract the image light coupled out of the coupling grating, wherein an orthographic projection of the first lens on the waveguide covers an entirety of the coupling-out grating. A head-mounted display device is also provided.

### FIELD

The present disclosure relates to an optical waveguide assembly and a head-mounted display device including the optical waveguide assembly.

### BACKGROUND

Near-eye display devices include augmented reality (AR) display devices, virtual reality (VR) display devices, mixed reality (MR) display devices, and extended reality (XR) display devices. Near-eye display devices can create virtual worlds or combine the real world and virtual worlds to generate new visual environments, with broad application prospects in critical fields such as military, medical, educational, gaming, and daily life.

For users with visual impairments, the near-eye display devices must be used in conjunction with corrective eyewear. Typically, when users wear the near-eye display devices over their corrective glasses, the overall weight is increased and the setup less stable, resulting in a poor user experience.

### BRIEF DESCRIPTION OF DRAWINGS

FIG. 1 is a perspective schematic diagram of a head-mounted display device according to an embodiment of the present disclosure.

FIG. 2 is a planar view of an optical waveguide assembly according to an embodiment of the present disclosure.

FIG. 3 is a cross-sectional view of the optical waveguide assembly along line III-III shown in FIG. 2.

FIG. 4 is a planar view of the optical waveguide assembly according to another embodiment of the present disclosure.

FIG. 5 is a planar view of the optical waveguide assembly according to another embodiment of the present disclosure.

FIG. 6 is cross-sectional view of the optical waveguide assembly along line V-V shown in FIG. 5.

FIG. 7 is a planar view of the optical waveguide assembly according to another embodiment of the present disclosure.

FIG. 8 is cross-sectional view of the optical waveguide assembly along line VII-VII shown in FIG. 7.

FIG. 9 is a schematic diagram showing curves of reflectivity of coating layers to image light changing with a wavelength of the image light.

### DETAILED DESCRIPTION

The technical solutions in the embodiments of the present disclosure will be described clearly and completely below in conjunction with the accompanying drawings. It is apparent that the described embodiments represent only a portion rather than all embodiments of the present disclosure.

It should be noted that when a component is referred to as being “fixed to” or “mounted to” another component, it may be directly attached to said component or intervening components may be present. When a component is considered to be “disposed on” another component, it may be directly placed thereon or intermediate components may coexist. The term “and/or” as used herein encompasses all possible combinations of one or more related listed items. The terminology employed in the specification of the present disclosure serves only to describe particular embodiments and is not intended to limit the disclosure.

To further illustrate the technical means employed by the present disclosure to achieve predetermined objectives and the resulting efficacy, the following detailed description will be made with reference to the accompanying drawings and preferred embodiments.

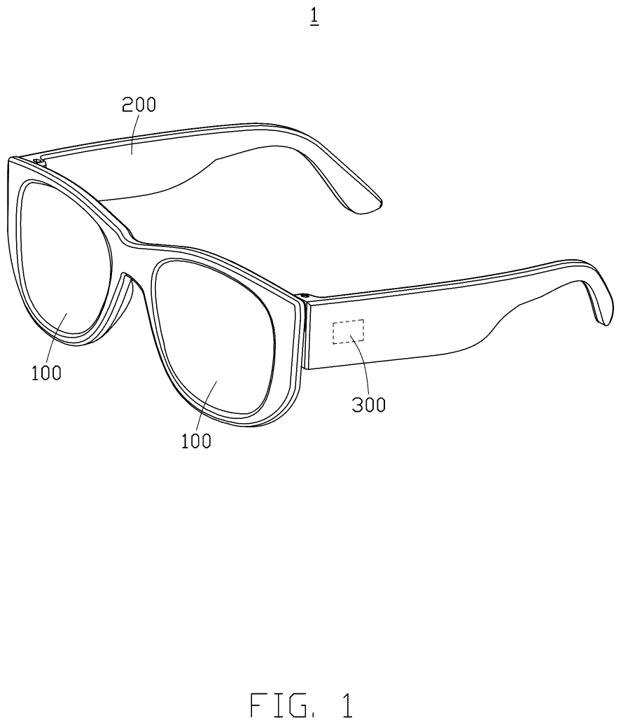

Referring to FIG. 1, a head-mounted display device 1 of the present embodiment includes an optical waveguide assembly 100, a frame 200, and a light engine 300. The light engine 300 is embedded within the frame 200 for emitting image light. The frame 200 is formed with an installation position, the optical waveguide assembly 100 is fixed to the installation position and is used to guide the image light to human eye, so that an user can observe image displayed by the head-mounted display device 1 after receiving the image light.

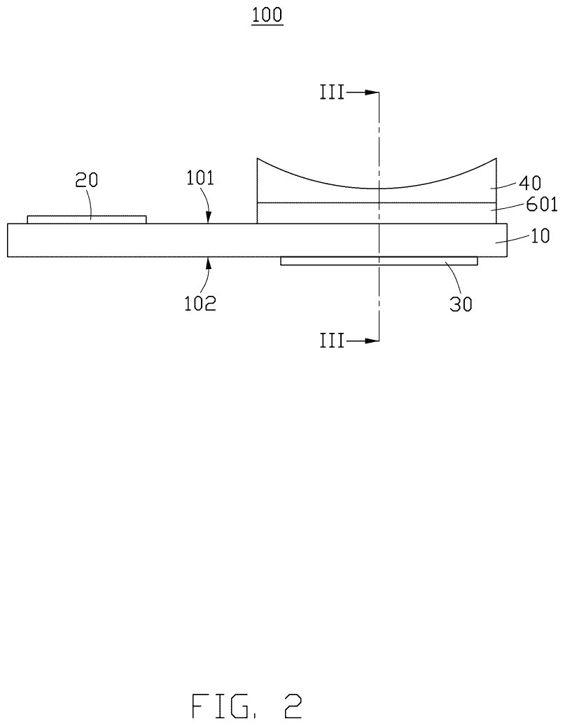

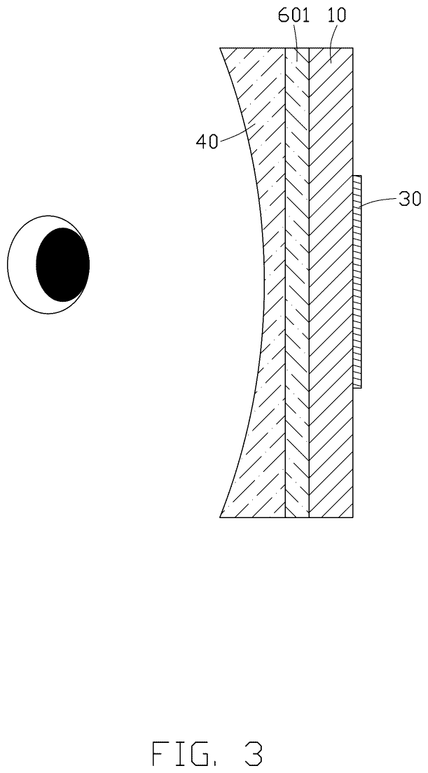

Referring to FIG. 2 and FIG. 3, The optical waveguide assembly 100 of the present embodiment includes a waveguide 10, a coupling-in grating 20, and a coupling-out grating 30. The waveguide 10 includes a first surface 101 and a second surface 102 opposite and parallel to the first surface 101. If both the coupling-in grating 20 and the coupling-out grating 30 are transmissive gratings, the coupling-in grating 20 and the coupling-out grating 30 are spaced apart from each other and are positioned on a same surface (the first surface 101 or the second surface 102) of the waveguide 10. If one of the coupling-in grating 20 and the coupling-out grating 30 is a transmissive grating and the other is a reflective grating, the coupling-in grating 20 and the coupling-out grating 30 are respectively on the first surface 101 and the second surface 102, and orthographic projections of the coupling-in grating 20 and the coupling-out grating 30 on the waveguide 10 are spaced apart from each other. The coupling grating 20 is on a light path of the image light and is used to couple the image light into the waveguide 10 to make the image light and transmit it towards the coupling grating 30 inside the waveguide 10. The coupling grating 30 is used to couple the image light out of the waveguide 10.

The optical waveguide assembly 100 further includes a first lens 40 fixed to one side of the waveguide 10 that emits image light. The first lens 40 is used to refract the image light coupled out from the coupling-in grating 30, so that the image light can be received by the human eye and enter a retina of the human eye, thereby allowing visually impaired users to see clear images. The orthographic projection of the first lens 40 on the waveguide 10 completely covers the coupling-out grating 30, allowing the first lens 40 to receive and transmit all the image light coupled out from the coupling-out grating 30. The first lens 40 can be made of one or more transparent or semi-transparent materials such as glass, plastic, etc.

The first lens 40 is fixed to the waveguide 10 through a first transparent optical adhesive 601, which fills a gap between the first lens 40 and the waveguide 10. A transmittance of the first transparent optical adhesive 601 is generally greater than 90%, thereby, by fixing the first lens 40 and the waveguide 10 through the transparent optical adhesive 60, it is beneficial to improve a transmittance of the optical waveguide assembly 100 to ambient light. The first transparent optical adhesive 601 is liquid optical adhesive or solid optical adhesive. If the first transparent optical adhesive 601 is liquid optical adhesive, the first lens 40 is fixed to the waveguide 10 through liquid dispensing process and UV curing process. If the first transparent optical adhesive 601 is solid optical adhesive, the first lens 40 is fixed to the waveguide 10 through solid bonding process. A refractive index of the first transparent optical adhesive 601 is less than 1.4, and a refractive index of the waveguide 10 is greater than 1.8, which is conducive to a total reflection of the image light in the waveguide 10. The first transparent optical adhesive 601 can be OCA (Optical Clear Adhesive) or LOCA (Liquid Optical Clear Adhesive).

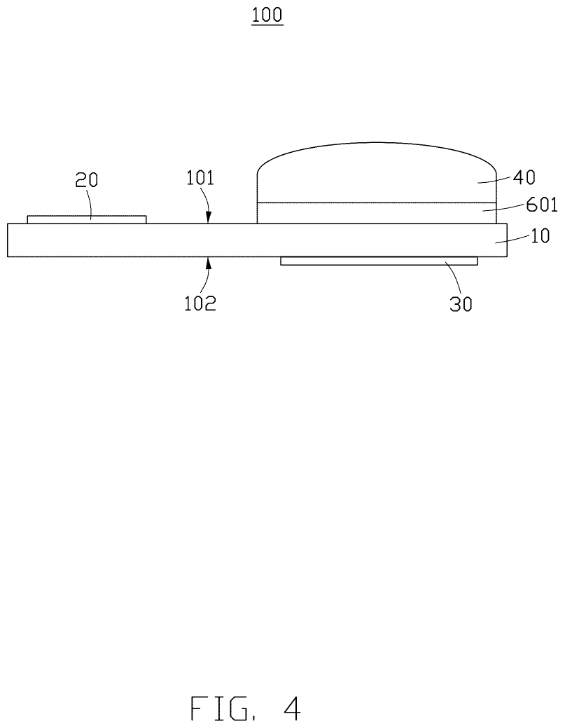

Referring to FIG. 2 and FIG. 4, the first lens 40 is a concave lens or a convex lens. A surface of the first lens 40 facing the waveguide 10 is flat, and a surface of the first lens 40 facing away from the waveguide 10 is a smooth curved surface. FIG. 2 is a planar view of the optical waveguide assembly 100 when the first lens 40 is a concave lens, and FIG. 4 is a planar view of the optical waveguide assembly 100 when the first lens 40 is a convex lens. When the first lens 40 is a concave lens, the optical waveguide assembly 100 is suitable for people with myopic, and when the first lens 40 is a convex lens, the optical waveguide assembly 100 is suitable for people with hyperopia.

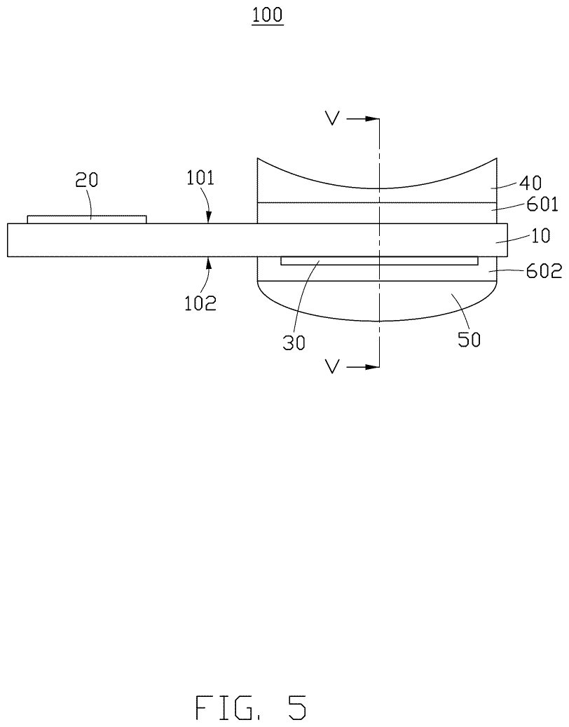

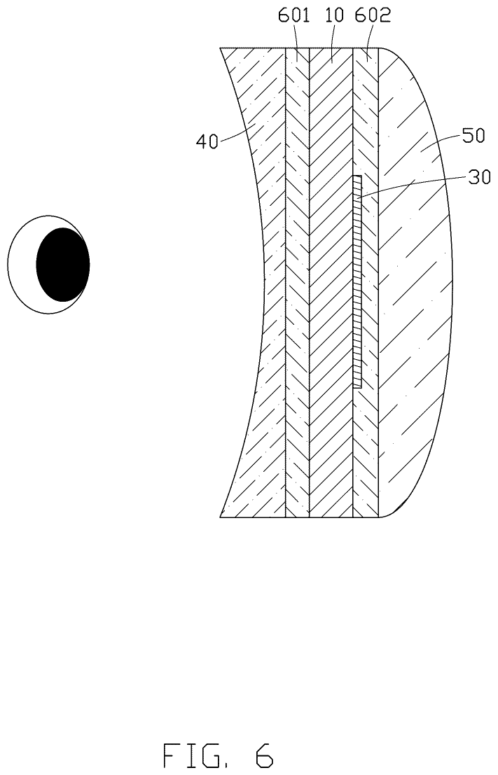

Referring to FIG. 5 and FIG. 6, in some embodiments, the optical waveguide assembly 100 further includes a second lens 50 fixed to a side of the waveguide 10 away from the first lens 40. The second lens 50 is used to refract the ambient light and make the ambient light entering the human eye after transmitted by the waveguide 10, so that the ambient light can reach the retina of the human eye, thereby imaging the ambient light on the retina of the human eye. An orthographic projection of the second lens 50 on the waveguide 10 completely covers the coupling-out grating 30, which is beneficial for allowing the ambient light to pass through the waveguide 10 and be received by the human eye after coupled out of the coupling-out grating 30. An optical axis of the second lens 50 coincides with an optical axis of the first lens 40. The second lens 50 is fixed to the waveguide 10 through a second transparent optical adhesive 602, which fills a gap between the second lens 50 and the waveguide 10. The second lens 50 can be made of one or more transparent or semi-transparent materials such as glass, plastic, etc.

The second lens 50 can be a convex lens. A surface of the second lens 50 facing the waveguide 10 is flat, and a surface of the second lens 50 facing away from the waveguide 10 is a smooth and curved surface. The second lens 50 is used to refract the ambient light into the waveguide 10, allowing the ambient light to pass through the waveguide 10 and couple out of the coupling-out grating 30, and be received by the human eye, ultimately converging onto the retina of the human eye.

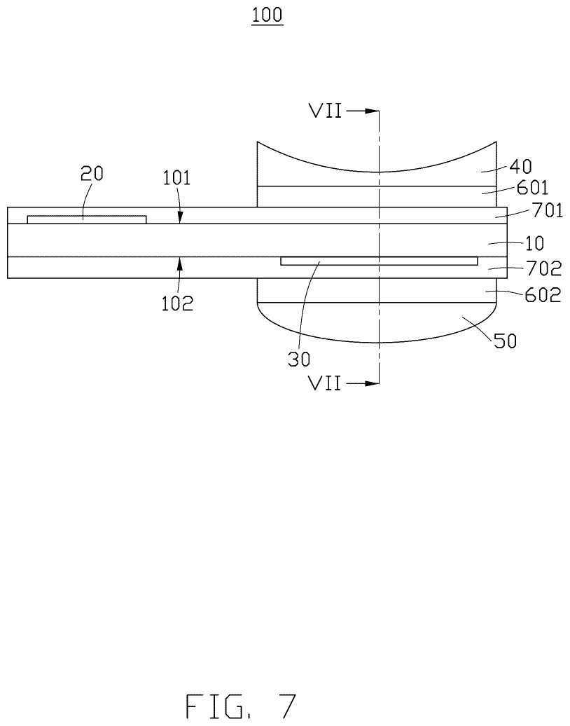

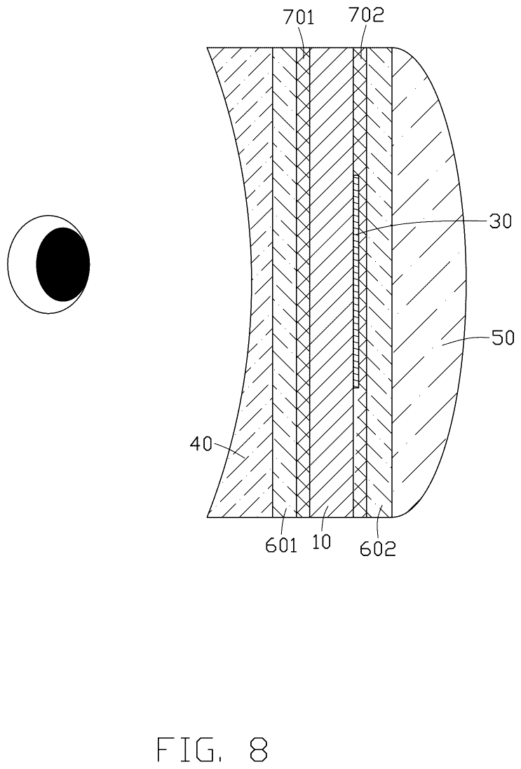

Referring to FIG. 7 and FIG. 8, in some embodiments, the first surface 101 of the waveguide 10 is coated with a first coating layer 701 and the second surface 102 of the waveguide 10 is coated with a second coating layer 702. The first coating layer 701 is between the first surface 101 and the first transparent optical adhesive 601, and the second coating layer 702 is between the second surface 102 and the second transparent optical adhesive 602. The first coating layer 701 is contact with the first surface 101 and the first transparent optical adhesive 601 directly, and the second coating layer 702 is contact with the second surface 102 and the second transparent optical adhesive 602 directly. An orthographic projection of the first coating layer 701 on the waveguide 10 coincides with the first surface 101 of the waveguide 10, and an orthographic projection of the second coating layer 702 on the waveguide 10 coincides with the second surface 102 of the waveguide 10. The first coating layer 701 covers an entirety of the coupling-in grating 20, and the second coating layer 702 covers an entirety of the coupling-out grating 30. The first coating layer 701 and the second coating layer 702 are used to increase reflectivity of the first surface 101 and the second surface 102 to the image light when the image light is travelling in the waveguide 20, so that more image light can travel toward the coupling-out grating 30 after alternately reflected by the first surface 101 and the second surface 102. The first coating layer 701 and the second coating layer 702 can be dielectric films.

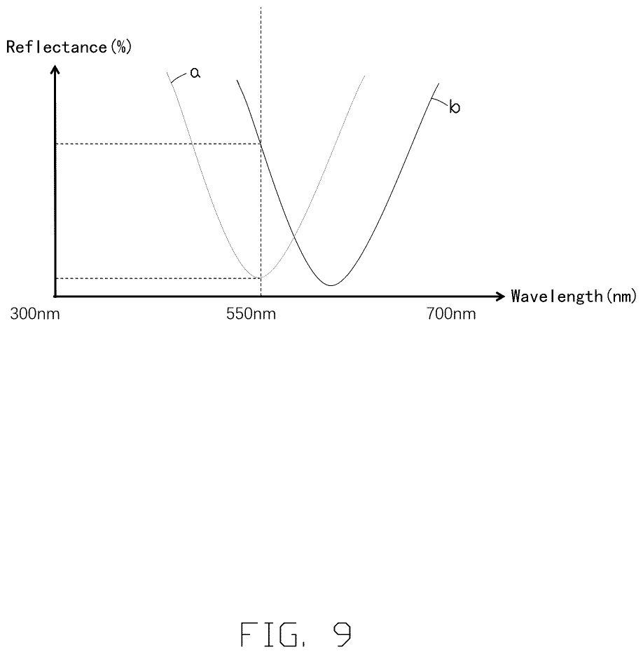

Referring to FIG. 9, curve “a” represents the reflectivity of coating layers (including the first coating layer 701 and the second coating layer 702) versus a wavelength of the image light when an incident angle of the image light on the first surface 101 or the second surface 102 greater than a critical angle for total internal reflection, and curve “b” represents the reflectivity of the first coating layer 701 and the second coating layer 702 versus the wavelength of the image light when the incident angle of the image light on the first surface 101 or the second surface 102 less than a critical angle for total internal reflection.

In at least one embodiment, the wavelength of the image light emitted by the light engine in the head-mounted display device is 550 nm. As shown in FIG. 9, when the wavelength of the image light is 550 nm, the coating layers have low reflectivity to the image light represented by the curve “a”, and the coating layers have high reflectivity to the image light represented by the curve “b”. Since the incident angle of the image light represented by the curve “a” is greater than the total reflection angle, the image light represented by the curve “a” can be alternately reflected by the first surface 101 and the second surface 102 and transmitted towards the coupled grating 30., Since the coating layer 70 has a high reflectivity to the image light represented by the curve “b”, even though the incident angle of the image light represented by the curve “b” is smaller than the total reflection angle, a large part of the image light represented by the curve “b” can be reflected by the coating layer 70, so that the large part of the image light represented by the curve “b” can be alternately reflected by the first surface 101 and the second surface 102 and transmitted towards the coupling-out grating 30.

The optical waveguide assembly 100 is coated with different types of coating layers on the first surface 101 and the second surface 102 of the waveguide 10 according to different wavelengths of the image light emitted by the light engine in the head-mounted display device, which makes the coating layers have high reflectivity to the image light with the incident angle smaller than the total reflection angle. Therefore, the image light with the incident angle smaller than the total reflection angle when it can be alternately reflected by the first surface 101 and the second surface 102 and transmitted towards the coupling grating 30, which is conducive to improving a transmission efficiency of the waveguide 10 for the image light, thereby increasing an amount of the image light coupled out from the coupling-out grating 30 and improving a brightness of the image observed by the human eye.

In the optical waveguide assembly 100 of the present embodiment, the first lens 40 is directly connected to the waveguide 10 through the first transparent optical adhesive 601 and the second lens 50 is directly connected to the waveguide 10 through the second transparent optical adhesive 602, so that users with visual defects can see the image clearly when wearing the head-mounted display device including the optical waveguide assembly 100 without wearing additional vision correction goggles, which is conducive to reducing a total weight of equipment worn by the users and improving its portability. The first lens 40 and the second lens 50 are fixed to opposite sides of the waveguide 10, which is beneficial for protecting the waveguide 10 from wear and tear. Moreover, by using the first transparent optical adhesive 601 and the second transparent optical adhesive 602 to fix the first lens 40 and the second lens 50 to the waveguide 10, it is beneficial to improve the transmittance of the ambient light when it enters the human eye through the optical waveguide assembly 100, and to enhance the brightness of the image observed by the human eye.

The embodiments shown and described above are only examples. Many details are often found in the art such as the other features of a light-emitting assembly and a display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical waveguide assembly comprising:
a waveguide comprising a first surface and a second surface opposite to the first surface;
a coupling-in grating;
a coupling-out grating spaced apart from the coupling-in grating, wherein the coupling-in grating and the coupling-out grating are on a same surface of the waveguide or on the first surface and the second surface of the waveguide, respectively; the coupling-in grating is configured to couple image light into the waveguide; the waveguide is configured to guide the image light toward the coupling-out grating; and the coupling-out grating is configured to couple the image light out of the waveguide; and
a first lens fixed to a side of the waveguide emitting the image light and configured to refract the image light coupled out of the coupling grating, wherein an orthographic projection of the first lens on the waveguide covers an entirety of the coupling-out grating.

2. The optical waveguide assembly according to claim 1, wherein the first surface is coated with a first coating layer and the second surface is coated with a second coating layer; the first coating layer and the second coating layer increase reflectivity of the first surface and the second surface to the image light, respectively.

3. The optical waveguide assembly according to claim 2, wherein the first coating layer and the second coating layer are dielectric films.

4. The optical waveguide assembly according to claim 1, wherein the first lens is a concave lens or a convex lens.

5. The optical waveguide assembly according to claim 1, wherein the first lens is fixed to the waveguide through a first transparent optical adhesive.

6. The optical waveguide assembly according to claim 5, further comprising a second lens fixed to a side of the waveguide away from the first lens, wherein an orthographic projection of the second lens on the waveguide covers an entirety of the coupling-out grating.

7. The optical waveguide assembly according to claim 6, wherein an optical axis of the first lens coincides with an optical axis of the second lens.

8. The optical waveguide assembly according to claim 6, wherein the second lens is a convex lens.

9. The optical waveguide assembly according to claim 6, wherein the second lens is fixed to the waveguide through a second transparent optical adhesive.

10. The optical waveguide assembly according to claim 9, wherein the first transparent optical adhesive and the second transparent optical adhesive are liquid optical adhesives or solid optical adhesives.

11. The optical waveguide assembly according to claim 9, wherein a refractive index of the first transparent optical adhesive and a refractive index of the second transparent optical adhesive is each less than 1.4.

12. The optical waveguide assembly according to claim 1, wherein a refractive index of the waveguide is greater than 1.8.

13. A head-mounted display device comprising:
a frame defining an installation position;
a light engine embedded within the frame and configured for emitting image light; and
an optical waveguide assembly fixed to the installation position and comprising:
a waveguide comprising a first surface and a second surface opposite to the first surface;
a coupling-in grating on a light path of the image light;
a coupling-out grating spaced apart from the coupling-in grating, wherein the coupling-in grating and the coupling-out grating are on a same surface of the waveguide or on the first surface and the second surface of the waveguide, respectively, the coupling-in grating is configured to couple the image light into the waveguide; the waveguide is configured to guide the image light toward the coupling-out grating, and the coupling-out grating is configured to couple the image light out of the waveguide; and
a first lens fixed to a side of the waveguide emitting the image light and configured to refract the image light coupled out of the coupling grating, wherein an orthographic projection of the first lens on the waveguide covers an entirety of the coupling-out grating.

14. The head-mounted display device according to claim 13, wherein the first surface is coated with a first coating layer and the second surface is coated with a second coating layer; the first coating layer and the second coating layer increase reflectivity of the first surface and the second surface to the image light, respectively.

15. The head-mounted display device according to claim 14, wherein the first coating layer and the second coating layer are dielectric films.

16. The head-mounted display device according to claim 13, wherein the first lens is fixed to the waveguide through a first transparent optical adhesive.

17. The head-mounted display device according to claim 16, wherein the optical waveguide assembly further comprises a second lens fixed to a side of the waveguide away from the first lens, wherein an orthographic projection of the second lens on the waveguide covers an entirety of the coupling-out grating.

18. The head-mounted display device according to claim 17, wherein an optical axis of the first lens coincides with an optical axis of the second lens.

19. The head-mounted display device according to claim 17, wherein the second lens is a convex lens.

20. The head-mounted display device according to claim 17, wherein the second lens is fixed to the waveguide through a second transparent optical adhesive, and the second transparent optical adhesive is a liquid optical adhesive or a solid optical adhesive.
